(19) United States
(12) Patent Application Publication
(10) Pub. No.: US 2014/0055273 A1
(43) Pub. Date: Feb. 27, 2014

(54) METHOD OF ALARMING ABNORMAL STATE OF AUTOMATED MANUFACTURING SYSTEM BASED ON PLC SIGNAL PATTERN

(71) Applicants: Hyeong Tae Park, Seoul (KR); Chol Hwan Kim, Gyeonggi-do (KR); Gi Nam Wang, Gyeonggi-do (KR); Sang Chul Park, Gyeonggi-do (KR); Jin Young Cho, Ulsan (KR); Jung Ho Nam, Ulsan (KR)

(72) Inventors: Hyeong Tae Park, Seoul (KR); Chol Hwan Kim, Gyeonggi-do (KR); Gi Nam Wang, Gyeonggi-do (KR); Sang Chul Park, Gyeonggi-do (KR); Jin Young Cho, Ulsan (KR); Jung Ho Nam, Ulsan (KR)

(73) Assignee: UDMTEK CO., LTD., Gyeonggi-do (KR)

(21) Appl. No.: 14/114,444

(22) PCT Filed: Jul. 22, 2011
(86) PCT No.: PCT/KR2011/005429

§ 371 Date: Nov. 12, 2013

(30) Foreign Application Priority Data
Apr. 28, 2011 (KR) 10-2011-0040103

(51) Int. Cl. G05B 19/05; G08B 21/18

(52) U.S. Cl. CPC G05B 19/058; G08B 21/18
USPC 340/653

(57) ABSTRACT

A method of alarming an abnormal state of a line of an automated manufacturing system using a programmable logic controller (PLC) signal pattern is provided. The method includes obtaining a plurality of change sequences of a plurality of PLC signals for control of the line in a normal operating system by repeating a cycle for which the line is sequentially controlled by the PLC signals that are transmitted and received between a PLC and the line according to an operation of PLC internal logic; acquiring a reference sequence from a plurality of the change sequences, wherein the reference sequence indicates an order of change of a plurality of the PLC signals for control of the line in a normal operating state; and determining whether the line is in a normal operating state or an abnormal operating system based on whether or not the reference sequence is matched with a change sequence of a plurality of PLC signals for control of the line in use after the acquisition of the reference sequence, and outputting a determination result.

### TECHNICAL FIELD

The following description relates to a method of alarming an abnormal state of a line of an automated manufacturing system based on a programmable logic controller (PLC) signal pattern, and more particularly, to a method of detecting an abnormal operation of a line of an automated manufacturing system based on a PLC signal for use in control of the automated manufacturing system and automatically alarming the abnormal state.

### BACKGROUND ART

Programmable logic controller (PLC) is an industrial computer that is programmed in a low level language for use in control of an automated system. A PLC program as an internal logic of a PLC controls an automated system through Boolean operation. According to IEC6113-3 and 4 standards, ladder logic diagram (LD) as shown in an example illustrated in FIG. 1 is known as a typical language generally used in a PLC program. A PLC program designed under a general manufacturing process may be verified and if the accuracy of the program is achieved, the program is used to control an automated system in practice.

In recent automated manufacturing industries, with the increase of complexity of manufacturing lines, control logic becomes extensive and complicated in design, and thus, logic of a PLC program becomes complex as well. For these reasons, it becomes more and more difficult to diagnose and monitor the PLC program, and accordingly a period of time for diagnosing and correcting errors gradually increases. According to Operational Diagnostics, The holy grail of control automation, a working delay due to such diagnosis and identification of errors is more than 80% of the overall equipment failure time. In particular, in a vehicle body assembly line, an average cycle time is around one minute, and hence if the line is stopped due to the equipment malfunction, a significant amount of loss can be incurred for a short period of time.

A general automated manufacturing system consists of a number of robots and automated conveying devices. The robots and conveying devices perform a variety of tasks such as welding and transport according to logic of a PLC program. A recent automated manufacturing system employs large-scale automated manufacturing lines with high complexity, and hence contains diverse causes of task failure such as errors in the own system due to the complexity and errors due to external causes such as intervention in a movement range of a robot. A delay due to a task failure during the process may cost an enormous economic loss which is caused by error detection and an increase in set-up time.

To diagnose the aforementioned errors, a code for diagnosis is added in a PLC program that controls processes and distribution flow, thereby monitoring an automated manufacturing system. Generally, in an auto industry as a representative example of automated manufacturing systems, when an error occurs on an auto manufacturing line, a PLC program is monitored through an error display module that shows predicted errors, as shown in FIG. 2. That is, the conventional monitoring method predicts areas of a high probability of occurrence of an error, and establishes and adds codes for error diagnosis target objects as shown in FIG. 2, and thus not all signals can be monitored. Therefore, the conventional method monitors only a limited range of processes, and thus has limitation as a monitoring method to detect gradual error. In other words, it is difficult to handle beforehand a task failure due to gradual degradation of devices or accessories.

### DISCLOSURE OF INVENTION

### Technical Problem

The following description relates to a method of alarming an abnormal state of a line of an automated manufacturing system based on a programmable logic controller (PLC) signal pattern, wherein the method is capable of detecting a gradual error in a monitoring target that is not limited to a part of the line of the automated manufacturing system.

### Solution to Problem

In one general aspect, there is provided a method of alarming an abnormal state of a line of an automated manufacturing system using a programmable logic controller (PLC) signal pattern, the method including: obtaining a plurality of change sequences of a plurality of PLC signals for control of the line in a normal operating system by repeating a cycle for which the line is sequentially controlled by the PLC signals that are transmitted and received between a PLC and the line according to an operation of PLC internal logic; acquiring a reference sequence from a plurality of the change sequences, wherein the reference sequence indicates an order of change of a plurality of the PLC signals for control of the line in a normal operating state; and determining whether the line is in a normal operating state or an abnormal operating system based on whether or not the reference sequence is matched with a change sequence of a plurality of PLC signals for control of the line in use after the acquisition of the reference sequence, and outputting a determination result.

The acquiring of the reference sequence may include arranging each of a plurality of the change sequences according to time, that is, along a time axis and extracting a common region as the reference sequence from the arranged change sequences.

The determining of whether the line is in a normal operating state or an abnormal operating system may be further based on whether or not a time interval between a plurality of PLC signals forming the reference sequence is matched with a time interval between a plurality of PLC signals forming the change sequence for control of the line in use after the acquisition of the reference signal.

The time interval between a plurality of the PLC signal forming the reference sequence may be a time interval between a plurality of PLC signals extracted as common from a plurality of PLC signals that form a plurality of the change sequences and are arranged according to time.

The time interval between a plurality of the PLC signals forming the reference sequence may be obtained by adding an allowable time set by a user to a time interval between a plurality of PLC signals which are extracted as common from a plurality of the PLC signals that form a plurality of the change sequences and are arranged according to time.

Other features and aspects may be apparent from the following detailed description, the drawings, and the claims.

### ADVANTAGEOUS EFFECTS OF INVENTION

According to a method of alarming an abnormal state of a line of an automated manufacturing system based on a PLC signal pattern in accordance with an exemplary embodiment, a plurality of change sequences of multiple PLC signals for control of the line in a normal operating system are obtained to infer a reference sequence for determining an abnormal state of the line. The reference sequence is compared with a change sequence of a plurality of PLC signals for control of the line in use, and based on the comparison result, an abnormal state of the line is determined. As a result, targets to be monitored are not necessarily limited to some lines of the automated manufacturing system, and errors occurring gradually in the targets to be monitored may be enabled to be detected.

### BRIEF DESCRIPTION OF DRAWINGS

FIG. 1 is a diagram illustrating an example of a ladder logic diagram (LD).

FIG. 2 is a diagram illustrating an example of an error display module for monitoring a programmable logic controller (PLC) program.

FIG. 3 is a flowchart illustrating an example of a method of alarming an abnormal state of a line of an automated manufacturing system based on a PLC signal pattern according to an exemplary embodiment of the present invention.

FIG. 4 is a diagram illustrating change in three PLC signals S1, S2, and S3 over time.

FIG. 5 is a diagram illustrating an example of a reference sequence formed by extracting a common region from multiple change sequences, each of which is arranged according to time.

FIG. 6 is a diagram illustrating an example of comparison between the reference sequence and a change sequence of a plurality of PLC signals for control of the line in use after the acquisition of the reference sequence.

FIGS. 7 and 8 are diagrams illustrating an example of comparison between time intervals of a plurality of PLC signals for determining an abnormal state of the line.

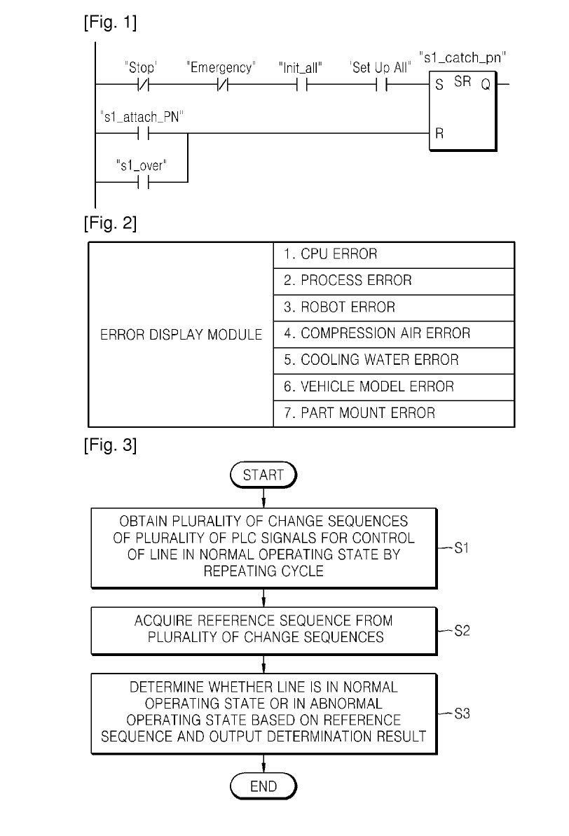

### BEST MODE FOR CARRYING OUT THE INVENTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

For implementation of a method of alarming an abnormal state of a line of an automated manufacturing system using a programmable logic controller (PLC) signal pattern according to an exemplary embodiment of the present invention, pattern analysis on a PLC signal that controls lines of the automated manufacturing system may be prerequisite. To this end, a memory value in a PLC of an actually driven line may be extracted suing, for example, object linking and embedding (OLE) for process control (OPC) technique.

OPC is a technique to be widely used for communication and interface in industrial control areas. OPC servers are primarily categorized into vendor-dedicated OPC servers for data access by a particular vendor PLC and universal PLC servers designed for interfacing with various PLC vendor products. The method of alarming an abnormal state of a line of an automated manufacturing system based on a PLC signal pattern in accordance with the exemplary embodiment reads an internal memory value of a hardware PLC through the OPC. According to the exemplary embodiment, the method may be a program that is implemented in a predefined programming language and thus can be run by a personal computer (PC)-based system, but the implementation of the method may not be limited thereto.

Generally, an OPC technique is mainly used for communications of a human machine interface (HMI) that is a control panel for manufacturing site control. The HMI panel may read out a PLC output signal from the PLC, and deliver to the PLC a characteristic signal that is manipulated by a manufacturing engineer as an input signal. That is, the PLC output signal is received and an input signal is delivered to the PLC. However, the method according the exemplary embodiment reads only input/output signals inside the PLC, focusing on a pattern of the input/output signals, without generating any signal for changing a state of the PLC. The method according to the exemplary embodiment recognizes and notifies an abnormal state of a line of an automated manufacturing system by reading input/output signals from the PLC.

FIG. 3 illustrates a flowchart of an example of a method of alarming an abnormal state of a line of an automated manufacturing system based on a PLC signal pattern. The method shown in the example illustrated in FIG. 3 may be performed by a PC-based system or by any other systems.

As shown in the example, in a normal operating state of the line in which a plurality of PLC signals are transmitted and received between the line and a PLC on a cycle-by-cycle basis according to an operation of PLC internal logic and the line is sequentially controlled by the PLC signals, multiple change sequences of a plurality of the PLC signals for control of the line of the normal operating state are obtained by repeating a cycle a number of times (S1) In this case, the PLC signals transmitted and received between the line and the PLC may be at least one of a PLC output signal which is generated by the PLC to be transmitted to the line and a PLC input signal which is generated by the line to be transmitted to the PLC.

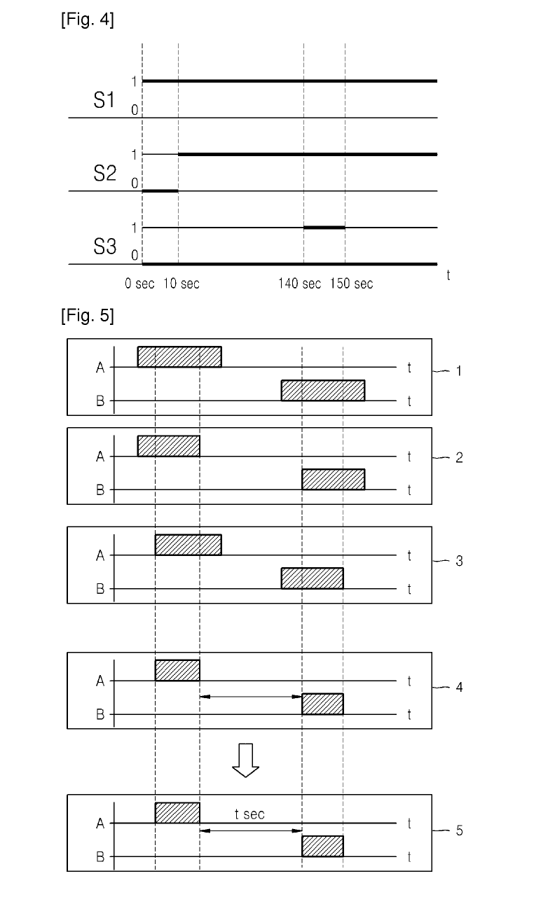

An example of change sequences of a plurality of the PLC signals for control of the line of a normal operating state is shown in FIG. 4.

The example illustrated in FIG. 4 shows change in three PLC signals S1, S2, and S3 over time. At an initial time (t=0), S1=1, S2=0, and S3=0. Thus, in a case where t=0, initial PLC signal patterns may be defined, respectively, as S1(1), S2(0), and S3(0). The initial PLC signal patterns may change one time when t=10. For example, when t=10, the PLC signal S2 changes from 0 to 1. Hence, it is possible to define the PLC signal patterns as S1(1), S2(1), and S3(0) when t=10. Between t=0 and t=10, the PCL signal patterns do not change at all. Thus, as information for forming a change sequence of a plurality of the PLC signals, only information of a region where the PLC signal pattern has changed can be used.

According to the aforementioned method, the change in each PLC signal with time may be evaluated. The change in the PLC signals S1, S2, and S3 shown in the example illustrated in FIG. 4 may be represented as below.

Ev.1 t=0 : S1(1), S2(0), S3(0).

Ev.2 t=10 : S1(1), S2(1), S3(0).

Ev.3 t=140 : S1(1), S2(1), S3(1).

Ev.4 t=150 : S1(1), S2(1), S3(0).

In monitoring of an abnormal state of a line of an automated manufacturing system, the change in the PLC signals S1, S2, and S3 is significant for inferring the change sequence of the PLC signals. That is, the change sequence of the PLC signals S1, S2, and S3 shown in the example illustrated in FIG. 4 can be represented simply as t=0(initial state)->S2(1)->S3(1)->S3(0), which is inferred from the change in the PLC signals S1, S2, and S3 over time.

The acquired change sequence of the PLC signals may be inferred from the change in the PLC signals, for one cycle, which are transmitted and received between the PLC and the line in a normal operating state in which the line is sequentially controlled according to an operation of the PLC internal logic. Although, a reference sequence for monitoring an abnormal state of the line may be acquired based on a plurality of the PLC signals for control of the line which is in normal operating state during one cycle, for more stable monitoring of the abnormal state of the line, it is required to repeat a procedure for acquiring a change sequence of the PLC signals for a number of times.

Thus, a procedure for acquiring a change sequence of a plurality of the PLC signals may be repeated a number of times to obtain multiple change sequences of the PLC signals.

Thereafter, by use of the obtained multiple change sequences, a reference sequence of an order of change of the PLC signals for control of the line in a normal operating state is obtained (S2). In this case, the reference sequence may be obtained by extracting a common region from the multiple change sequences, each of which is arranged according to time, that is, each of which is arranged along a time axis (t). An example of the arranged change sequences is shown in FIG. 5. An axis intersecting the time axis (t) may be an axis that represents a magnitude of an electrical quantity (voltage or current) of each PLC signal.

As shown in FIG. 5, each of four change sequences 1, 2, 3, and 4 is arranged along the time axis, and a common region therebetween may be extracted as a reference sequence 5.

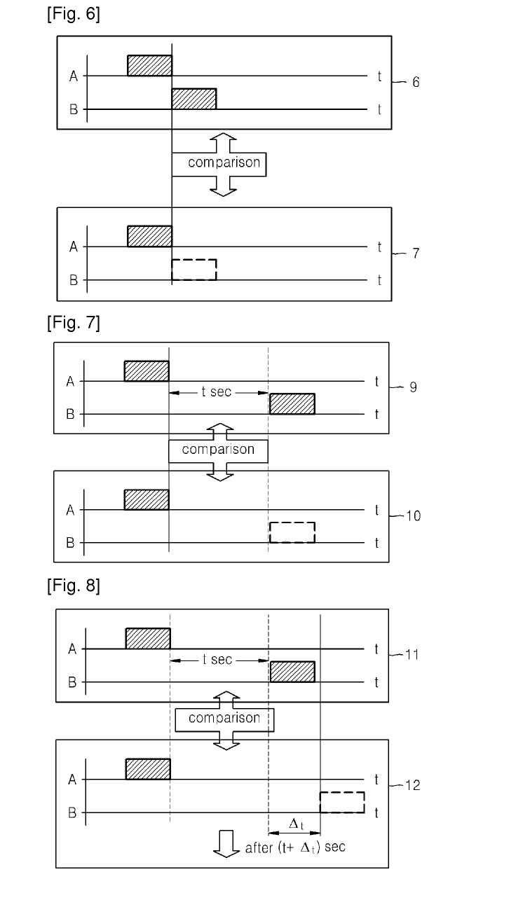

Referring to FIG. 3 again, it is detected whether the line of the automated manufacturing system is in a normal operating state or in an abnormal state by comparing the obtained reference sequence with a change sequence of a plurality of PLC signals for control of the line in use after the acquisition of the reference sequence and a detection result is output (S3). An example of the comparison is shown in FIG. 6.

As shown in the example illustrated in FIG. 6, in the comparison between a reference sequence 6 and a change sequence 7 of a plurality of PLC signals used for control of the line in in use after the acquisition of the reference sequence 6, it shows that a PLC signal B immediately flows a PLC signal A in the reference sequence 6, whereas the PLC signal B does not immediately follow the PLC signal A in the change sequence 7 of the PLC signals. Accordingly, the reference sequence 6 is not matched with the change sequence 7 so that it may be identified that the line is in an abnormal operating state. In other words, it may be determined that the line is in a normal operating system if the reference sequence is matched with a change sequence of a plurality of PLC signals that are used for control of the line in use after the acquisition of the reference sequence, and otherwise, it may be determined that the line is in an abnormal operating system.

In the method of alarming an abnormal state of a line for an automated manufacturing system based on a PLC signal pattern according to the exemplary embodiment, a normal state or an abnormal state of the line may be determined based on whether or not a reference sequence is matched with a change sequence of a plurality of PLC signals for control of the line in use after the acquisition of the reference sequence. In addition, the normal state or the abnormal state of the line may be determined further based on whether or not a time interval between a plurality of PLC signals forming the reference sequence is matched with a time interval between a plurality of PLC signals forming the change sequence for control of the line in use after the acquisition of the reference signal.

Examples of the above determination of a normal state or an abnormal state of the line based on whether or not the time intervals are matched between the reference sequence and the change sequence are shown in FIGS. 7 and 8. Referring to FIG. 7, in a reference sequence 9 a PLC signal B follows a PLC signal A after a time interval of t, whereas in a change sequence 10 of a plurality of PLC signals for control of the line in use after the acquisition of the reference sequence, the PLC signal B does not follow the PLC signal A after a time interval of t. Hence, because the reference sequence 9 and the change sequence 10 are not matched together, it can be determined that the line is in an abnormal operating state. That is, if a time interval between a plurality of PLC signals forming the reference sequence is matched with a time interval between a plurality of PLC signals forming the change sequence for control of the line in use after the acquisition of the reference sequence, it may be determined that the line is in a normal operating state, and otherwise, it may be determined that the line is in an abnormal operating state.

In this case, the time interval of a plurality of the PLC signals which forming the reference sequence may be the time interval of a plurality of the PLC signals formed by extracting a common region from a plurality of change sequences that are arranged according to time, as shown in the example illustrated in FIG. 5.

Referring to FIG. 8, in a reference sequence 11 a PLC signal B follows a PLC signal A after a time interval of t, whereas in a change sequence 12 of a plurality of PLC signals for control of a line in use after the acquisition of the reference sequence, the PLC signal B does not follow the PLC signal A after the time interval of t. Thus, since the reference sequence 11 and the change sequence 12 are not matched with each other, it may be determined that the line is in an abnormal operating system. Furthermore, in the example, the time interval between the PLC signals forming the reference sequence may be lengthened by an allowable time At that is set by a user. Consequently, the time interval is extended by At, and if the PLC signal B follows the PLC signal A within the extended time interval, it may be determined that the line is in an abnormal state.

In this case, the time interval between the PLC signals forming the reference sequence as a determination criterion may be obtained by adding the allowable time At to a time interval t between a plurality of PLC signals obtained by extracting common regions from multiple PLC signals which, respectively, form a plurality of change sequences, as shown in the example illustrated in FIG. 5.

As described above, according to a method of alarming an abnormal state of a line of an automated manufacturing system based on a PLC signal pattern in accordance with an exemplary embodiment, a plurality of change sequences of multiple PLC signals for control of the line in a normal operating system are obtained to infer a reference sequence for determining an abnormal state of the line. The reference sequence is compared with a change sequence of a plurality of PLC signals for control of the line in use, and based on the comparison result, an abnormal state of the line is determined. As a result, targets to be monitored are not necessarily limited to some lines of the automated manufacturing system, and errors occurring gradually in the targets to be monitored may be enabled to be detected.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

this invention can be used in the field of automated manufacturing system using PLC signal.

1. A method of alarming an abnormal state of a line of an automated
manufacturing system using a programmable logic controller (PLC) signal pattern, the method comprising:
obtaining a plurality of change sequences of a plurality of PLC signals for control of the line in a normal operating system by repeating a cycle for which the line is sequentially controlled by the PLC signals that are transmitted and received between a PLC and the line according to an operation of PLC internal logic;
acquiring a reference sequence from a plurality of the change sequences, wherein the reference sequence indicates an order of change of a plurality of the PLC signals for control of the line in a normal operating state; and
determining whether the line is in a normal operating state or an abnormal operating system based on whether or not the reference sequence is matched with a change sequence of a plurality of PLC signals for control of the line in use after the acquisition of the reference sequence, and outputting a determination result.

2. The method of claim 1, wherein the acquiring of the reference sequence comprises arranging each of a plurality of the change sequences according to time, that is, along a time axis and extracting a common region as the reference sequence from the arranged change sequences.

3. The method of claim 3, wherein the determining of whether the line is in a normal operating state or an abnormal operating system is further based on whether or not a time interval between a plurality of PLC signals forming the reference sequence is matched with a time interval between a plurality of PLC signals forming the change sequence for control of the line in use after the acquisition of the reference signal.

4. The method of one of claim 2, wherein the time interval between a plurality of the PLC signal forming the reference sequence is a time interval between a plurality of PLC signals extracted as common from a plurality of PLC signals that form a plurality of the change sequences and are arranged according to time.

5. The method of claim 4, wherein the time interval between a plurality of the PLC signals forming the reference sequence is obtained by adding an allowable time set by a user to a time interval between a plurality of PLC signals which are extracted as common from a plurality of the PLC signals that form a plurality of the change sequences and are arranged according to time.

6. The method of one of claim 3, wherein the time interval between a plurality of the PLC signal forming the reference sequence is a time interval between a plurality of PLC signals extracted as common from a plurality of PLC signals that form a plurality of the change sequences and are arranged according to time.
